(19) United States
(12) Patent Application Publication
(10) Pub. No.: US 2012/0147314 A1
(43) Pub. Date: Jun. 14, 2012

(54) DISPLAY DEVICE AND COLOR FILTER SUBSTRATE

(75) Inventors: Takenori Yoshizawa, Osaka-shi (JP); Keiichi Tanaka, Osaka-shi (JP)

(73) Assignee: SHARP KABUSHIKI KAISHA, Osaka-shi, Osaka (JP)

(21) Appl. No.: 13/391,857

(22) PCT Filed: Aug. 19, 2010
(86) PCT No.: PCT/JP2010/064005

§ 371 Date: Mar. 2, 2012

(30) Foreign Application Priority Data
Aug. 24, 2009 (JP) 2009-193388

(51) Int. Cl. G02F 1/1343; H05B 37/00; G02B 5/22

(52) U.S. Cl. 349/144; 359/891; 315/192

(57) ABSTRACT

The display device (100) of this invention has pixels (P) arranged in columns and rows to form a matrix pattern. Each pixel (P) is defined by subpixels (R, G, B, Y) arranged in m columns and n rows (where n and m are integers and n and m≧2) to form a matrix pattern and that include first, second, third and fourth subpixels (R, B, Y, G) representing first, second, third and fourth colors, respectively. In three arbitrary pixels (P) arranged in line in one of row and column directions, if the central one of the three is called a first pixel (P1) and the other two second and third pixels (P2, P3), the arrangement of the subpixels (R, G, B, Y) in the first pixel (P1) is different from that of the subpixels (R, G, B, Y) in the second and third pixels (P2, P3). The first subpixels (R) of the first and second pixels (P1, P2) are adjacent to each other, so are their second subpixels (B). The third subpixels (Y) of the first and third pixels (P1, P3) are adjacent to each other, so are their fourth subpixels (G). According to the present invention, a display device, of which each pixel is defined by four or more subpixels, can have its aperture ratio increased.

### TECHNICAL FIELD

The present invention relates to a display device and more particularly relates to a display device, of which a single pixel is defined by four or more subpixels. The present invention also relates to a color filter substrate for use in such a display device.

### BACKGROUND ART

Liquid crystal display devices and various other types of display devices are currently used in a variety of applications. In a general display device, a single pixel consists of three subpixels respectively representing red, green and blue, which are the three primary colors of light, thereby conducting a display operation in colors.

A conventional display device, however, can reproduce colors that fall within only a narrow range (which is usually called a “color reproduction range”), which is a problem. FIG. 21 shows the color reproduction range of a conventional display device that conducts a display operation using the three primary colors. Specifically, FIG. 21 shows an xy chromaticity diagram according to the XYZ color system, in which the triangle, formed by three points corresponding to the three primary colors of red, green and blue, represents the color reproduction range. Also plotted by crosses X in FIG. 21 are the surface colors of various objects existing in Nature, which were disclosed by Pointer (see Non-Patent Document No. 1). As can be seen from FIG. 21, there are some object colors that do not fall within the color reproduction range, and therefore, a display device that conducts a display operation using the three primary colors cannot reproduce some object colors.

Thus, in order to broaden the color reproduction range of display devices, a technique that uses an increased number of primary colors for display purposes has been proposed recently.

For example, Patent Document No. 1 discloses a liquid crystal display device 800 of which a single pixel P consists of six subpixels R, G, B, Y, C and M representing the colors red, green, blue, yellow, cyan and magenta, respectively, as shown in FIG. 22. That liquid crystal display device 800 conducts a display operation using these six primary colors. The color reproduction range of such a liquid crystal display device 800 is shown in FIG. 23. As shown in FIG. 23, the color reproduction range, represented by a hexagon of which the six vertices correspond to those six primary colors, covers almost all object colors, and is broader than that of the conventional display device shown in FIG. 21.

Naturally, the number of primary colors to use does not have to be six. For example, Patent Document No. 2 discloses liquid crystal display device 900 of which a single pixel P consists of four subpixels R, G, B and Y representing the colors red, green, blue, and yellow, respectively, as shown in FIG. 24. That liquid crystal display device 900 conducts a display operation using these four primary colors, and its color reproduction range is represented by a rectangular, of which the four vertices correspond to those four primary colors. Likewise, a liquid crystal display device that conducts a display operation using five primary colors has its color reproduction range represented by a pentagon, of which the five vertices correspond to five primary colors.

In this manner, by using four or more primary colors, the color reproduction range is represented by a polygon with four or more vertices. As a result, the color reproduction range can be broader than that of a conventional display device that conducts a display operation using the three primary colors (and that has its color reproduction range represented by a triangle).

In this description, a display device that carries out a display operation using four or more primary colors will be referred to herein as a “multi-primary-color display device” and a liquid crystal display device that carries out a display operation using four or more primary colors will be referred to herein as a “multi-primary-color liquid crystal display device”. Meanwhile, a conventional display device that carries out an ordinary display operation using the three primary colors will be referred to herein as a “three-primary-color display device” and a liquid crystal display device that carries out a display operation using the three primary colors will be referred to herein as a “three-primary-color liquid crystal display device”.

A liquid crystal display device is ordinarily provided with color filters that are respectively associated with those primary colors represented by each set of subpixels. Hereinafter, the structure of an ordinary active-matrix-addressed three-primary-color liquid crystal display device will be described with reference to FIG. 25.

The liquid crystal display device 1000 shown in FIG. 25 includes an active-matrix substrate 1010 and a counter substrate 1020, which are arranged so as to face each other, and a liquid crystal layer 1030, which is interposed between them.

The active-matrix substrate 1010 includes a transparent substrate 1011 and scan lines (not shown), signal lines 1013, thin-film transistors (TFTs; not shown), and pixel electrodes 1014, which are arranged on the transparent substrate 1011. Each of those scan lines is electrically connected to the gate electrodes of its associated TFTs and supplies a scan signal to those TFTs. Each of those signal lines is electrically connected to the source electrodes of its associated TFTs and supplies a video signal to those TFTs. Each of the pixel electrodes 1014 is electrically connected to the drain electrode of its associated TFT.

The color filter substrate 1020 includes a transparent substrate 1021 and red, green and blue color filters 1022R, 1022G and 1022B, a black matrix 1023, and a counter electrode (not shown), all of which are arranged on the transparent substrate 1021. The red, green and blue color filters 1022R, 1022G and 1022B are arranged so as to face the pixel electrodes 1014 on the active-matrix substrate 1010. Meanwhile, the black matrix 1023 is arranged to fill the gap between the color filters.

Now it will be described with reference to FIG. 26 how the color filter substrate 1020 may be fabricated.

First of all, as shown in FIG. 26(a), a black matrix 1023 is formed to have a grating pattern on a transparent substrate 1021. The black matrix 1023 may be formed by depositing a metallic material with low reflectivity (such as chromium) on the transparent substrate 1021 by sputtering and then etching that material, for example. Alternatively, the black matrix 1023 may also be formed by coating the transparent substrate 1021 with a photosensitive resin including a black pigment, exposing the resin to a radiation through a photomask to pattern it, and then developing the patterned resin.

Next, as shown in FIG. 26(b), the transparent substrate 1021 with the black matrix 1023 is coated with a photosensitive resin 1022R′ including a red pigment. Thereafter, the photosensitive resin 1022R′ is exposed to a radiation and patterned through a photomask, and then developed, thereby forming red color filters 1022R as shown in FIG. 26(c).

Subsequently, a similar process step is carried out using a photosensitive resin including a green pigment, thereby forming green color filters 1022G as shown in FIG. 26(d). Furthermore, a similar process step is carried out using a photosensitive resin including a blue pigment, thereby forming blue color filters 1022B as shown in FIG. 26(e).

After that, a transparent conductive material is deposited by sputtering over the red, green and blue color filters 1022R, 1022G and 1022B and the black matrix 1023, thereby forming a counter electrode. In this manner, the color filter substrate 1020 is completed.

### CITATION LIST

### Patent Literature

Patent Document No. 1: PCT International Application Japanese National-Phase Publication No. 2004-529396
Patent Document No. 2: Japanese Patent Publication No. 4034022

### Non-Patent Literature

Non-Patent Document No. 1: M. R. Pointer, “The Gamut of Real Surface Colors”, Color Research and Application, Vol. 5, No. 3, pp. 145-155 (1980)

### SUMMARY OF INVENTION

### Technical Problem

According to the method of fabricating the color filter substrate 1020 described above, a photolithographic process is adopted to make the color filters, and therefore, the manufacturing process should be designed with the magnitude of misalignment between the black matrix 1023 and the color filters taken into account. That is to say, in order to avoid leaving a gap between the black matrix 1023 and the respective color filters even when there is some misalignment between them, the process is designed so that the respective edges of the color filters overlap with the black matrix 1023 (see FIG. 25). For that reason, the width of the black matrix 1023 should be set to be much broader than the magnitude of the misalignment, and therefore, the aperture ratio cannot be increased sufficiently.

Such a problem gets even more serious in a multi-primary-color liquid crystal display device. This is because in a multi-primary-color liquid crystal display device, the number of subpixels that form a single pixel (that is four or more) is greater, and therefore, the area per subpixel becomes smaller, than in a three-primary-color liquid crystal display device. As described above, the width of the black matrix needs to be set to be much greater than the magnitude of misalignment. For that reason, it is impossible to reduce the width of the black matrix in order to compensate for the decrease in aperture ratio that has been caused by the decrease in the area of each subpixel in a multi-primary-color scheme.

It is therefore an object of the present invention to increase the aperture ratio of a display device, of which a single pixel is defined by four or more subpixels.

### Solution to Problem

A display device according to the present invention has a number of pixels that are arranged in columns and rows to form a matrix pattern. Each pixel is defined by a number of subpixels that are arranged in m columns and n rows (where n and m are integers that are equal to or greater than two) to form a matrix pattern in itself and that include first, second, third and fourth subpixels representing first, second, third and fourth colors, respectively. When attention is paid to a set of three arbitrary pixels that are arranged in line in one of row and column directions, if the central one of the three is called a first pixel and the other two are called second and third pixels, respectively, the arrangement of the subpixels in the first pixel is different from the arrangement of the subpixels in the second and third pixels. The respective first subpixels of the first and second pixels are adjacent to each other, so are the respective second subpixels of the first and second pixels. The respective third subpixels of the first and third pixels are adjacent to each other, so are the respective fourth subpixels of the first and third pixels.

In one preferred embodiment, the subpixels are four subpixels that are arranged in two columns and two rows to form a matrix pattern. When attention is paid to another set of three arbitrary pixels that are arranged in line in the other of the column and row directions, if the central one of the three is called a fourth pixel and the other two are called fifth and sixth pixels, respectively, the arrangement of the subpixels in the fourth pixel is different from the arrangement of the subpixels in the fifth and sixth pixels. The respective first subpixels of the fourth and fifth pixels are adjacent to each other, so are the respective third subpixels of the fourth and fifth pixels. The respective second subpixels of the fourth and sixth pixels are adjacent to each other, so are the respective fourth subpixels of the fourth and sixth pixels.

In another preferred embodiment, the first, second, third and fourth subpixels are red, green, blue and yellow subpixels representing the colors red, green, blue and yellow, respectively.

In still another preferred embodiment, the subpixels further include fifth and sixth subpixels representing fifth and sixth colors, respectively, the respective fifth subpixels of the first and second pixels are adjacent to each other, so are the respective sixth subpixels of the first and third pixels.

In this particular preferred embodiment, the first, second, third, fourth, fifth and sixth subpixels are red, green, blue, yellow, cyan and magenta subpixels representing the colors red, green, blue, yellow, cyan and magenta, respectively.

Another display device according to the present invention has a number of pixels that are arranged in columns and rows to form a matrix pattern. Each pixel is defined by four subpixels that are arranged in two columns and two rows to form a matrix pattern in itself and that are first, second, third and fourth subpixels representing first, second, third and fourth colors, respectively. When attention is paid to two arbitrary pixels that are arranged adjacent to each other in a row direction, each subpixel of one of the two pixels and its associated subpixel of the other pixel are arranged symmetrically to each other with respect to a boundary between the two pixels. And when attention is paid to two arbitrary pixels that are arranged adjacent to each other in a column direction, each subpixel of one of the two pixels and its associated subpixel of the other pixel are arranged symmetrically to each other with respect to a boundary between the two pixels.

In one preferred embodiment, the display device of the present invention is a liquid crystal display device including two substrates and a liquid crystal layer that is interposed between the two substrates.

In this particular preferred embodiment, the display device of the present invention further includes columnar spacers, which define the gap between the two substrates. But no columnar spacers are provided between two adjacent subpixels that represent the same color.

A color filter substrate according to the present invention is used to make a display device, which has a number of pixels that are arranged in columns and rows to form a matrix pattern. The color filter substrate includes a transparent substrate, and multiple color filters, which are arranged in an area on the transparent substrate so as to face the pixels. The color filters are arranged in m columns and n rows (where n and m are integers that are equal to or greater than two) to form a matrix pattern in that area and that include first, second, third and fourth color filters that transmit light rays representing first, second, third and fourth colors, respectively. When attention is paid to a set of three arbitrary pixels that are arranged in line in one of row and column directions, if the central one of the three is called a first pixel and the other two are called second and third pixels, respectively, the arrangement of the color filters in a region associated with the first pixel is different from the arrangement of the color filters in regions associated with the second and third pixels. The respective first color filters in two regions associated with the first and second pixels are adjacent to each other, so are the respective second color filters in the two regions associated with the first and second pixels. The respective third color filters in two regions associated with the first and third pixels are adjacent to each other, so are the respective fourth color filters in the two regions associated with the first and third pixels.

In one preferred embodiment, the color filters are four color filters that are arranged in two columns and two rows to form a matrix pattern. When attention is paid to another set of three arbitrary pixels that are arranged in line in the other of the column and row directions, if the central one of the three is called a fourth pixel and the other two are called fifth and sixth pixels, respectively, the arrangement of the color filters in a region associated with the fourth pixel is different from the arrangement of the color filters in regions associated with the fifth and sixth pixels. The respective first color filters in two regions associated with the fourth and fifth pixels are adjacent to each other, so are the respective third color filters in the two regions associated with the fourth and fifth pixels. The respective second color filters in two regions associated with the fourth and sixth pixels are adjacent to each other, so are the respective fourth color filters in the two regions associated with the fourth and sixth pixels.

In another preferred embodiment, the first, second, third and fourth color filters are red, green, blue and yellow color filters, respectively.

In still another preferred embodiment, the color filters further include fifth and sixth color filters that transmit light rays representing fifth and sixth colors, respectively. The respective fifth color filters in two regions that are associated with the first and second pixels are adjacent to each other, so are the respective sixth color filters in two regions that are associated with the first and third pixels.

In yet another preferred embodiment, the first, second, third, fourth, fifth and sixth color filters are red, green, blue, yellow, cyan and magenta color filters, respectively.

### Advantageous Effects of Invention

According to the present invention, the aperture ratio of a display device, of which a single pixel is defined by four or more subpixels, can be increased.

### BRIEF DESCRIPTION OF DRAWINGS

FIG. 1 is a plan view schematically illustrating a liquid crystal display device 100 as a preferred embodiment of the present invention.

FIG. 2 is a plan view schematically illustrating the liquid crystal display device 100 as the preferred embodiment of the present invention.

FIG. 3 is a plan view schematically illustrating the liquid crystal display device 100 as the preferred embodiment of the present invention.

FIGS. 4(a) and 4(b) are cross-sectional views schematically illustrating the liquid crystal display device 100 as the preferred embodiment of the present invention as respectively viewed on the planes 4A-4A′ and 4B-4B′ shown in FIG. 2.

FIGS. 5(a) and 5(b) are cross-sectional views schematically illustrating the liquid crystal display device 100 as the preferred embodiment of the present invention as respectively viewed on the planes 5A-5A′ and 5B-5B′ shown in FIG. 3.

FIG. 6 is a plan view schematically illustrating the liquid crystal display device 100 as the preferred embodiment of the present invention.

FIG. 7 is a plan view schematically illustrating a liquid crystal display device 200 as another preferred embodiment of the present invention.

FIG. 8 is a plan view schematically illustrating the liquid crystal display device 200 as the preferred embodiment of the present invention.

FIG. 9 is a plan view schematically illustrating the liquid crystal display device 200 as the preferred embodiment of the present invention.

FIG. 10 is a plan view schematically illustrating a liquid crystal display device 200′ as still another preferred embodiment of the present invention.

FIG. 11 is a plan view schematically illustrating the liquid crystal display device 200′ as the preferred embodiment of the present invention.

FIG. 12 is a plan view schematically illustrating the liquid crystal display device 200′ as the preferred embodiment of the present invention.

FIG. 13 is a plan view schematically illustrating a liquid crystal display device 300 as yet another preferred embodiment of the present invention.

FIG. 14 is a plan view schematically illustrating the liquid crystal display device 300 as the preferred embodiment of the present invention.

FIG. 15 is a plan view schematically illustrating the liquid crystal display device 300 as the preferred embodiment of the present invention.

FIGS. 16(a), 16(b) and 16(c) are cross-sectional views schematically illustrating the liquid crystal display device 300 as the preferred embodiment of the present invention as respectively viewed on the planes 16A-16A′, 16B-16B′ and 16C-16C′ shown in FIG. 14.

FIG. 17 is a plan view schematically illustrating a liquid crystal display device 300′ as yet another preferred embodiment of the present invention.

FIG. 18 is a plan view schematically illustrating the liquid crystal display device 300′ as the preferred embodiment of the present invention.

FIG. 19 is a plan view schematically illustrating the liquid crystal display device 300′ as the preferred embodiment of the present invention.

FIG. 20 is a plan view schematically illustrating a liquid crystal display device 400 as yet another preferred embodiment of the present invention.

FIG. 21 shows the color reproduction range of a conventional liquid crystal display device that conducts a display operation using the three primary colors.

FIG. 22 is a plan view schematically illustrating a conventional multi-primary-color liquid crystal display device 800.

FIG. 23 shows the color reproduction range of the multi-primary-color liquid crystal display device 800 shown in FIG. 22.

FIG. 24 is a plan view schematically illustrating a conventional multi-primary-color liquid crystal display device 900.

FIG. 25 is a cross-sectional view schematically illustrating a three-primary-color liquid crystal display device 1000.

FIGS. 26(a) through 26(e) are cross-sectional views illustrating respective manufacturing processing steps to fabricate the color filter substrate 1020 of the three-primary-color liquid crystal display device 1000 shown in FIG. 25.

### DESCRIPTION OF EMBODIMENTS

Hereinafter, preferred embodiments of the present invention will be described with reference to the accompanying drawings. It should be noted, however, that the present invention is in no way limited to the specific preferred embodiments to be described below.

### Embodiment 1

FIG. 1 illustrates a liquid crystal display device 100 as a first specific preferred embodiment of the present invention. As shown in FIG. 1, the liquid crystal display device 100 has a number of pixels P, which are arranged in columns and rows to form a matrix pattern.

Each of these pixels P is defined by four subpixels that are arrange in two columns and two rows to form a matrix pattern in the pixel P itself. Specifically, the four subpixels that define each pixel P are red, green, blue and yellow subpixels R, G, B and Y representing the colors red, green, blue, and yellow, respectively.

The liquid crystal display device 100 is a multi-primary-color liquid crystal display device that carries out a display operation using the four primary colors (i.e., red, green, blue, and yellow) represented by the red, green, blue, and yellow subpixels R, G, B and Y, respectively.

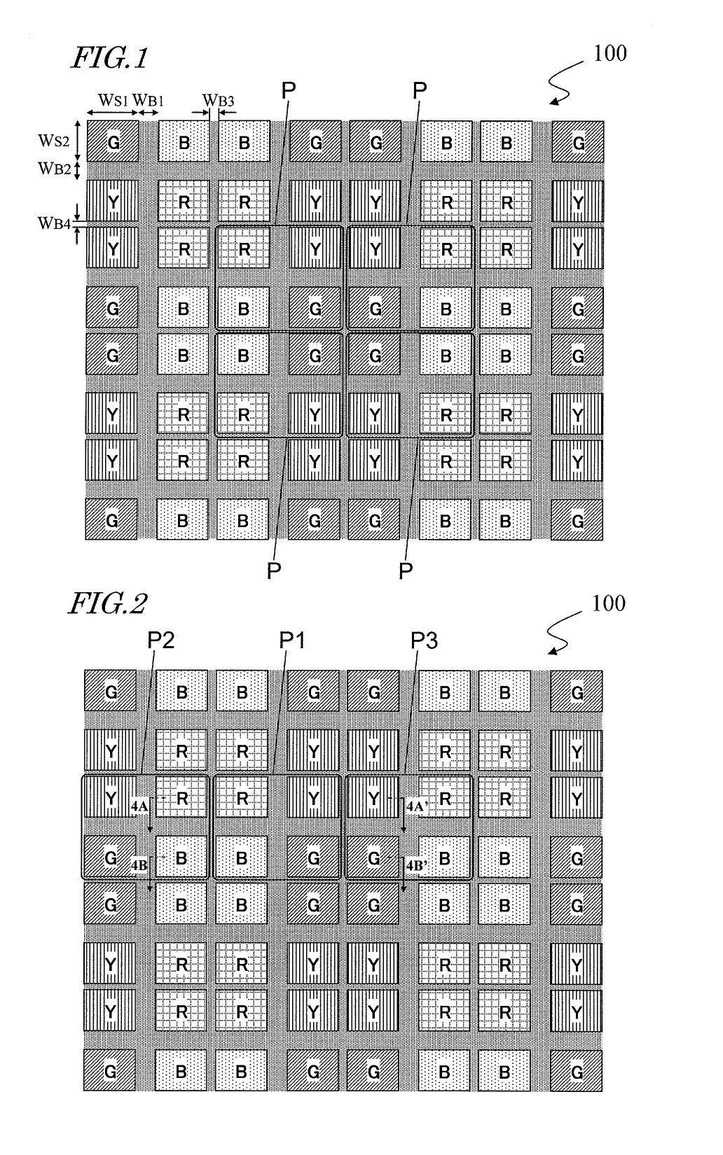

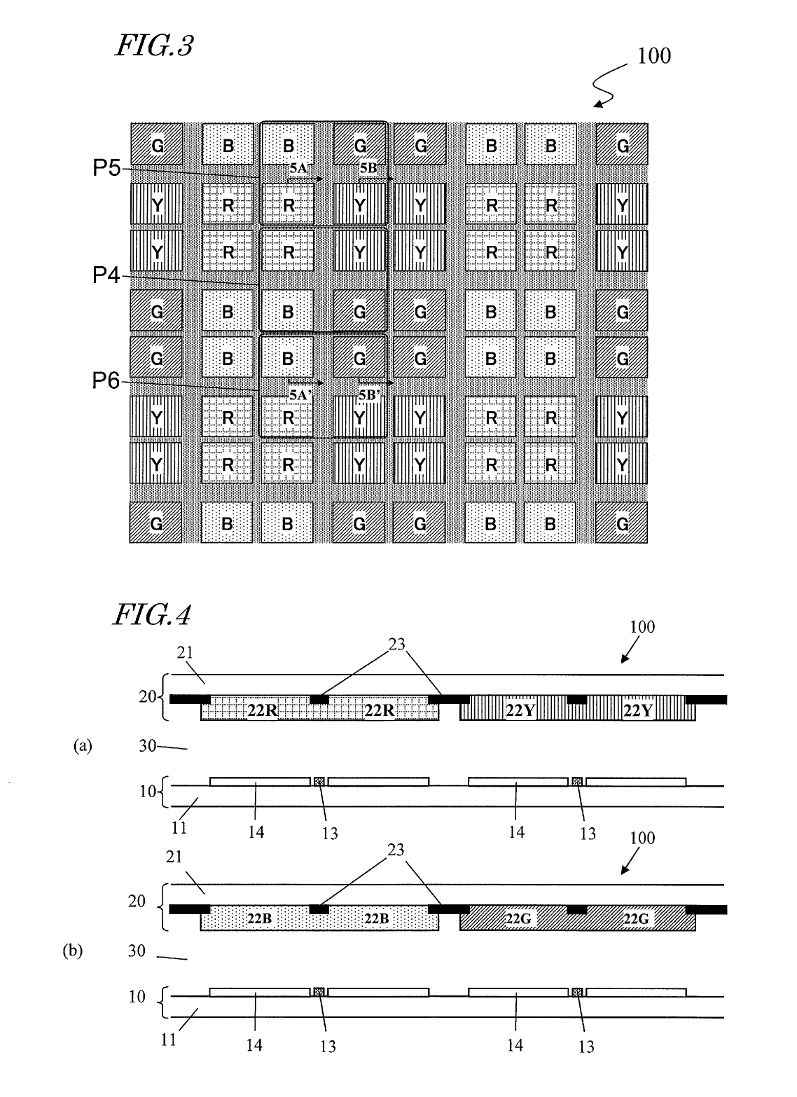

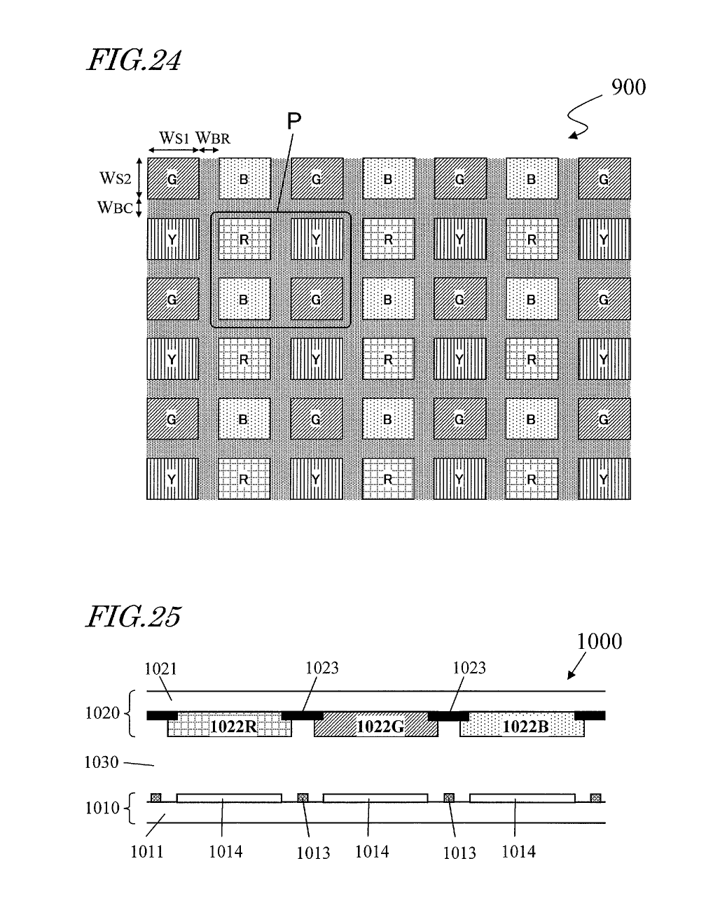

In the conventional multi-primary-color liquid crystal display device 900 shown in FIG. 24, every pixel P has the same arrangement of subpixels. On the other hand, in the liquid crystal display device 100 of this preferred embodiment, one of two adjacent pixels P has a different arrangement of subpixels from the other pixel P. This point will be described in further detail with reference to FIGS. 2 and 3.

As shown in FIG. 2, when attention is paid to a set of three arbitrary pixels that are arranged in line in the row direction, if the central one of the three is called a first pixel P1 and the other two are called second and third pixels P2 and P3, respectively, the arrangement of the subpixels in the first pixel P1 is different from that of the subpixels in the second and third pixels P2 and P3.

Specifically, red, blue, green and yellow subpixels R, B, G and Y are arranged at the upper left, lower left, lower right and upper right corners, respectively (i.e., counterclockwise from the upper left corner) in the first pixel P1 but at the upper right, lower right, lower left and upper left corners, respectively (i.e., clockwise from the upper right corner) in the second and third pixels P2 and P3.

If the subpixels are arranged in such patterns, the respective red subpixels R of the first and second pixels P1 and P2 are adjacent to each other, so are the respective blue subpixels B of the first and second pixels P1 and P2 as shown in FIG. 2. Furthermore, the respective yellow subpixels Y of the first and third pixels P1 and P3 are adjacent to each other, so are the respective green subpixels G of the first and third pixels P1 and P3.

As shown in FIG. 3, when attention is paid to another set of three arbitrary pixels that are arranged in line in the column direction, if the central one of the three is called a fourth pixel P4 and the other two are called fifth and sixth pixels P5 and P6, respectively, the arrangement of the subpixels in the fourth pixel P4 is different from that of the subpixels in the fifth and sixth pixels P5 and P6.

Specifically, red, blue, green and yellow subpixels R, B, G and Y are arranged at the upper left, lower left, lower right and upper right corners, respectively (i.e., counterclockwise from the upper left corner) in the fourth pixel P4 but at the lower left, upper left, upper right and lower right corners, respectively (i.e., clockwise from the lower left corner) in the fifth and sixth pixels P5 and P6.

If the subpixels are arranged in such patterns, the respective red subpixels R of the fourth and fifth pixels P4 and P5 are adjacent to each other, so are the respective yellow subpixels Y of the fourth and fifth pixels P4 and P5 as shown in FIG. 3. Furthermore, the respective blue subpixels B of the fourth and sixth pixels P4 and P6 are adjacent to each other, so are the respective green subpixels G of the fourth and sixth pixels P4 and P6.

As can be seen, in this liquid crystal display device 100, two subpixels representing the same color are adjacent to each other in any two adjacent pixels P, no matter whether the pixels P are arranged in the row direction or in the column direction. In other words, in two arbitrary pixels P that are adjacent to each other in the row direction (e.g., the first and second pixels P1 and P2 or the first and third pixels P1 and P3 in FIG. 2), each subpixel of one of the two pixels P and its associated subpixel of the other pixel P are arranged symmetrically to each other with respect to the boundary between the two pixels P. On the other hand, in two arbitrary pixels P that are adjacent to each other in the column direction (e.g., the fourth and fifth pixels P4 and P5 or the fourth and sixth pixels P4 and P6 in FIG. 3), each subpixel of one of the two pixels P and its associated subpixel of the other pixel P are arranged symmetrically to each other with respect to the boundary between the two pixels P.

FIGS. 4 and 5 illustrate cross-sectional structures of the liquid crystal display device 100. FIGS. 4(a) and 4(b) are cross-sectional views as viewed on the planes 4A-4A′ and 4B-4B′, respectively, shown in FIG. 2. FIGS. 5(a) and 5(b) are cross-sectional views as viewed on the planes 5A-5A′ and 5B-5B′, respectively, shown in FIG. 3.

As shown in FIGS. 4 and 5, the liquid crystal display device 100 includes an active-matrix substrate 10 (which will be referred to herein as a “TFT substrate”), a color filter substrate (which will sometimes be referred to herein as a “counter substrate”) 20, which is arranged to face the TFT substrate 10, and a liquid crystal layer 30 interposed between the TFT substrate 10 and the color filter substrate 20.

The liquid crystal layer 30 may be what is used in any of various display modes. According to the mode of display adopted, the liquid crystal layer 30 is made of a liquid crystal material that has either positive or negative dielectric anisotropy.

The TFT substrate 10 includes a transparent substrate 11 (e.g., a glass substrate) with an electrically insulating property, and scan lines 12, signal lines 13, thin-film transistors (TFTs; not shown) and pixel electrodes 14, all of which are arranged on the transparent substrate 11. Each of the scan lines 12 is electrically connected to the gate electrodes of its associated TFTs and supplies a scan signal to the TFTs. Each of the signal lines 13 is electrically connected to the source electrodes of its associated TFTs and supplies a video signal to the TFTs. Each of the pixel electrodes 14 is provided for its associated subpixel and is electrically connected to the drain electrode of the TFT.

The color filter substrate 20 includes a transparent substrate 21 (e.g., a glass substrate) with an electrically insulating property, multiple sets of color filters 22R, 22G, 22B and 22Y, each set of which is provided in a region allocated to an associated one of the pixels P, a black matrix 23 (opaque portion), which is made of an opaque material, and a counter electrode (not shown), which faces the pixel electrodes 14. The color filters 22R, 22G, 22B and 22Y, the black matrix 23 and the counter electrode are arranged on the transparent substrate 21.

Those color filters 22R, 22G, 22B and 22Y are arranged in two columns and two rows in a region allocated to its associated pixel P so as to form a matrix pattern. Specifically, those color filters 22R, 22G, 22B and 22Y are red, green, blue and yellow color filters 22R, 22G, 22B and 22Y transmitting light rays representing the colors red, green, blue, and yellow, respectively. Each of the red, green, blue, and yellow color filters 22R, 22G, 22B and 22Y is arranged so as to face its associated pixel electrode 14 on the TFT substrate 10. The black matrix 23 is arranged so as to fill the gap between each pair of adjacent color filters.

As already described with reference to FIG. 2, the arrangement of multiple subpixels in the first pixel P1 is different from that of subpixels in the second and third pixels P2 and P3. Accordingly, the arrangement of those color filters 22R, 22G, 22B and 22Y in the region associated with the first pixel P1 is different from that of color filters 22R, 22G, 22B and 22Y in the regions associated with the second and third pixels P2 and P3.

Specifically, as red, blue, green and yellow subpixels R, B, G and Y are arranged at the upper left, lower left, lower right and upper right corners, respectively, in the first pixel P1, the red, blue, green and yellow color filters 22R, 22B, 22G and 22Y are also arranged at the upper left, lower left, lower right and upper right corners, respectively (i.e., counterclockwise from the upper left corner). On the other hand, as red, blue, green and yellow subpixels R, B, G and Y are arranged at the upper right, lower right, lower left and upper left corners, respectively, in the second and third pixels P2 and P3, the red, blue, green and yellow color filters 22R, 22B, 22G and 22Y are also arranged at the upper right, lower right, lower left and upper left corners, respectively (i.e., clockwise from the upper right corner).

If those color filters 22R, 22G, 22B and 22Y are arranged in such patterns, the respective red color filters 22R in the regions associated with the first and second pixels P1 and P2 are adjacent to each other as shown on the left-hand side of FIG. 4(a) and the respective blue color filters 22B in the regions associated with the first and second pixels P1 and P2 are adjacent to each other as shown on the left-hand side of FIG. 4(b). Furthermore, the respective yellow color filters 22Y in the regions associated with the first and third pixels P1 and P3 are adjacent to each other as shown on the right-hand side of FIG. 4(a) and the respective green color filters 22G in the regions associated with the first and third pixels P1 and P3 are adjacent to each other as shown on the right-hand side of FIG. 4(b)

As already described with reference to FIG. 3, the arrangement of multiple subpixels in the fourth pixel P4 is different from that of subpixels in the fifth and sixth pixels P5 and P6. Accordingly, the arrangement of those color filters 22R, 22G, 22B and 22Y in the region associated with the fourth pixel P4 is different from that of color filters 22R, 22G, 22B and 22Y in the regions associated with the fifth and sixth pixels P5 and P6.

Specifically, as red, blue, green and yellow subpixels R, B, G and Y are arranged at the upper left, lower left, lower right and upper right corners, respectively, in the fourth pixel P4, the red, blue, green and yellow color filters 22R, 22B, 22G and 22Y are also arranged at the upper left, lower left, lower right and upper right corners, respectively (i.e., counterclockwise from the upper left corner). On the other hand, as red, blue, green and yellow subpixels R, B, G and Y are arranged at the lower left, upper left, upper right, and lower right corners, respectively, in the fifth and sixth pixels P5 and P6, the red, blue, green and yellow color filters 22R, 22B, 22G and 22Y are also arranged at the lower left, upper left, upper right, and lower right corners, respectively (i.e., clockwise from the lower left corner).

If those color filters 22R, 22G, 22B and 22Y are arranged in such patterns, the respective red color filters 22R in the regions associated with the fourth and fifth pixels P4 and P5 are adjacent to each other as shown on the left-hand side of FIG. 5(a) and the respective yellow color filters 22Y in the regions associated with the fourth and fifth pixels P4 and P5 are adjacent to each other as shown on the left-hand side of FIG. 5(b). Furthermore, the respective blue color filters 22B in the regions associated with the fourth and sixth pixels P4 and P6 are adjacent to each other as shown on the right-hand side of FIG. 5(a) and the respective green color filters 22G in the regions associated with the fourth and sixth pixels P4 and P6 are adjacent to each other as shown on the right-hand side of FIG. 5(b).

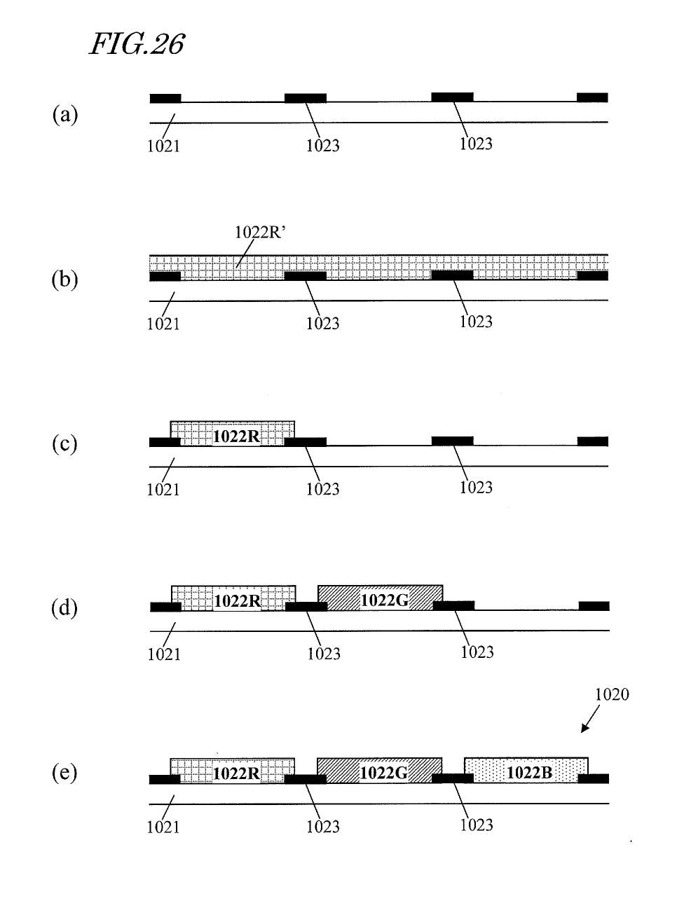

As can be seen, in the color filter substrate 20 of this liquid crystal display device 100, two color filters in the same color are adjacent to each other in any two adjacent pixels P, no matter whether the pixels P are arranged in the row direction or in the column direction. As already described with reference to FIG. 26, the color filter substrate 20 can be fabricated by a manufacturing process that uses a photolithography. However, as shown in FIGS. 4 and 5, each pair of mutually adjacent color filters in the same color are arranged in line (i.e., formed integrally). That is why a portion of the black matrix 23 that is located between those subpixels representing the same color is entirely covered with the material of the color filters.

As described above, in the liquid crystal display device 100 of this preferred embodiment, two subpixels representing the same color are adjacent to each other in any two adjacent pixels P, no matter whether the pixels P are arranged in the row direction or in the column direction. In each region where subpixels representing the same color are adjacent to each other, color filters in the same color can be arranged in line as shown in FIGS. 4 and 5. That is why even if misalignment has occurred, no gap (i.e., a region where there is no color filter) will be left between the black matrix 23 and the color filters. Consequently, as for a portion of the black matrix 23 that is located between subpixels representing the same color, there is no need to take misalignment between the black matrix 23 and the color filters into consideration and a margin that should be left in case of misalignment can be cut down. As a result, that portion of the black matrix 23 that is located between those subpixels representing the same color can have a narrower width than another portion of the black matrix 23 that is located between subpixels representing mutually different colors, and the aperture ratio can be increased accordingly compared to the conventional one.

The present inventors carried out experiments to confirm exactly how much the aperture ratio could be increased effectively by the present invention. In the example to be described below, in the liquid crystal display device 100 of this preferred embodiment shown in FIG. 1 and in the conventional liquid crystal display device 900 shown in FIG. 24, the widths WS1 and WS2 of each subpixel as measured in the row and column directions, respectively, were both supposed to be 185 μm.

If the arrangement of the conventional liquid crystal display device 900 was adopted, the widths WBR and WBC of the black matrix as measured in the row and column directions were 18 # m and 26 # m, respectively, and the aperture ratio was 79.9% when the misalignment between the black matrix and the color filters was taken into account.

In the liquid crystal display device 100 of this preferred embodiment, on the other hand, the widths WB1 and WB2 of a portion of the black matrix 23 located between subpixels representing mutually different colors were 18 μm and 26 μm as measured in the row and column directions, respectively. However, the widths WB3 and WB4 of another portion of the black matrix 23 located between subpixels representing the same color were 10 μm and 22 μm as measured in the row and column directions, respectively, and the aperture ratio was 82.3%. That is to say, the aperture ratio could be increased by 2.4%.

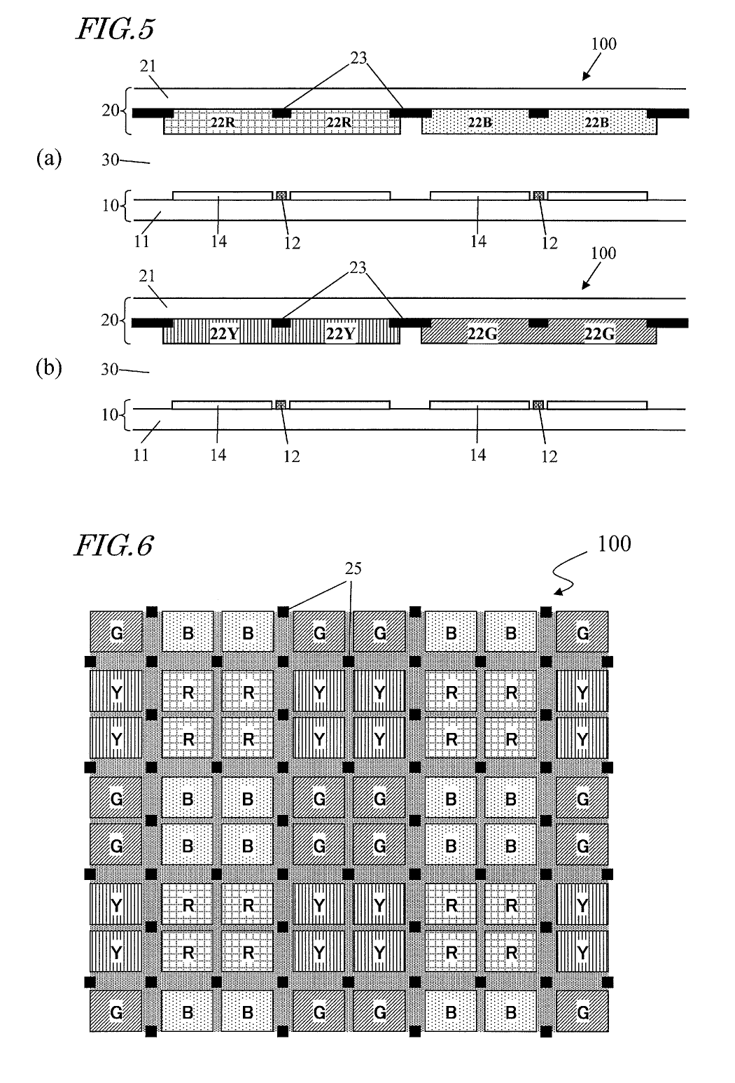

Next, a more preferred arrangement of the liquid crystal display device 100 will be described with reference to FIG. 6. As shown in FIG. 6, the liquid crystal display device 100 includes a number of columnar spacers 25 that define the gap (which is called a “cell gap”) between the TFT substrate 10 and the color filter substrate 20. The columnar spacers 25 are typically arranged on the color filter substrate 20 and may be made of a photosensitive resin, for example.

In the arrangement shown in FIG. 6, no columnar spacers 25 are arranged between adjacent subpixels representing the same color. As already described with reference to FIGS. 4 and 5, a portion of the black matrix 23 that is located between subpixels representing the same color is entirely covered with the material of the color filters. That is why if any of columnar spacers 25 were arranged between such subpixels representing the same color, the heights of those columnar spacers 25 (i.e., the heights of the top of the columnar spacers 25 as measured from the surface of the transparent substrate 21) would vary from one spacer to another. On the other hand, if no columnar spacers 25 are arranged between those subpixels representing the same color as shown in FIG. 6, then such a variation in height can be eliminated and a uniform cell gap can be achieved.

### Embodiment 2

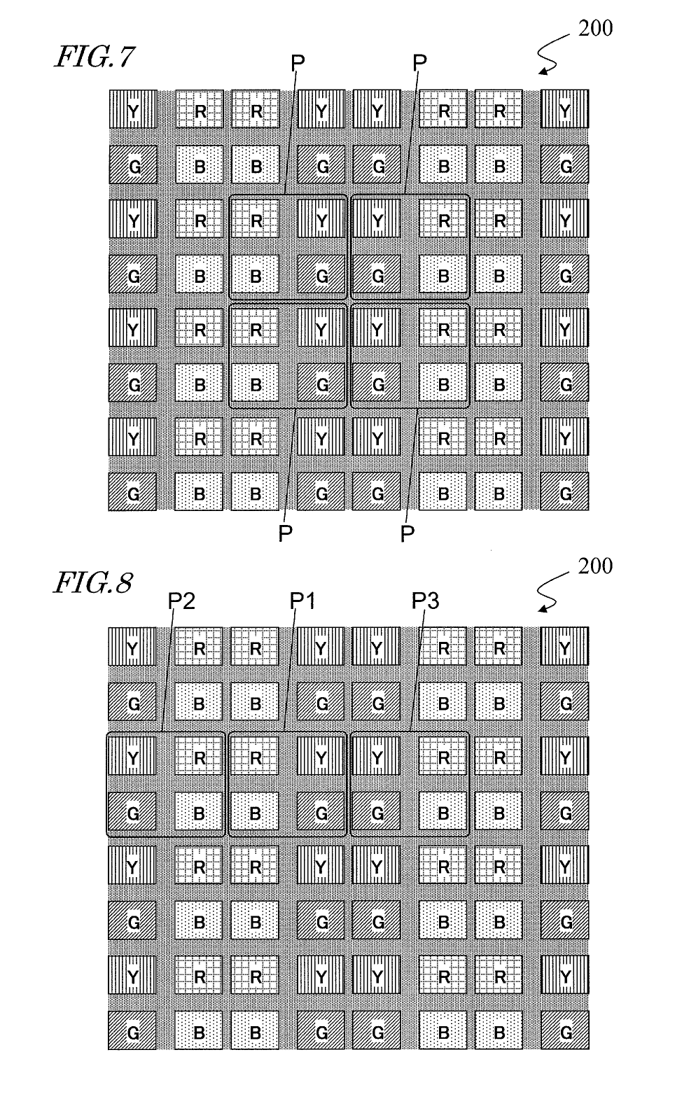

FIG. 7 illustrates a liquid crystal display device 200 as a second specific preferred embodiment of the present invention. Just like each pixel P of the liquid crystal display device 100, each of multiple pixels P of this liquid crystal display device 200 is also defined by red, green, blue, and yellow subpixels R, G, B and Y, which are arranged in two columns and two rows to form a matrix pattern. In the liquid crystal display device 200 of this preferred embodiment, however, each pair of pixels P that are adjacent to each other in the row direction have mutually different arrangements of subpixels but each pair of pixels P that are adjacent to each other in the column direction have the same arrangement of subpixels. Hereinafter, such an arrangement will be described in further detail with reference to FIGS. 8 and 9.

As shown in FIG. 8, when attention is paid to a set of three arbitrary pixels that are arranged in line in the row direction, if the central one of the three is called a first pixel P1 and the other two are called second and third pixels P2 and P3, respectively, the arrangement of the subpixels in the first pixel P1 is different from that of the subpixels in the second and third pixels P2 and P3.

Specifically, red, blue, green and yellow subpixels R, B, G and Y are arranged at the upper left, lower left, lower right and upper right corners, respectively (i.e., counterclockwise from the upper left corner) in the first pixel P1 but at the upper right, lower right, lower left and upper left corners, respectively (i.e., clockwise from the upper right corner) in the second and third pixels P2 and P3.

If the subpixels are arranged in such patterns, the respective red subpixels R of the first and second pixels P1 and P2 are adjacent to each other, so are the respective blue subpixels B of the first and second pixels P1 and P2 as shown in FIG. 8. Furthermore, the respective yellow subpixels Y of the first and third pixels P1 and P3 are adjacent to each other, so are the respective green subpixels G of the first and third pixels P1 and P3.

Meanwhile, when attention is paid to another set of three arbitrary pixels that are arranged in line in the column direction, if the central one of the three is called a fourth pixel P4 and the other two are called fifth and sixth pixels P5 and P6, respectively, the arrangement of the subpixels is the same in all of the fourth, fifth and sixth pixels P4, P5 and P6 as shown in FIG. 9.

As described above, in this liquid crystal display device 200, subpixels representing the same color are adjacent to each other only between two pixels P that are adjacent to each other in the row direction. That is why the margin that should be left just in case of misalignment cannot be reduced in the column direction but can be reduced in the row direction. As a result, a portion of the black matrix 23 that is located between subpixels representing the same color can have a decreased width, and therefore, the aperture ratio can be increased compared to the conventional one, in the row direction.

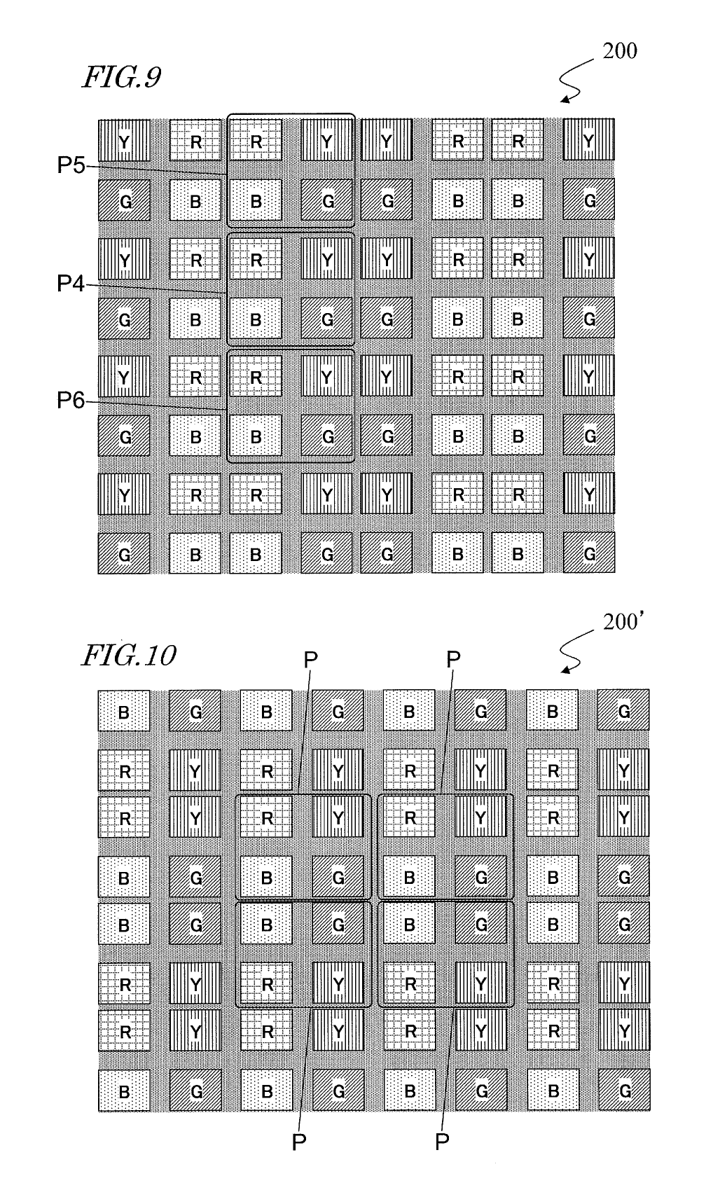

Although an arrangement in which subpixels representing the same color are adjacent to each other only in the row direction is shown in FIGS. 7 to 9, subpixels representing the same color may also be adjacent to each other only in the column direction as in the liquid crystal display device 200′ shown in FIG. 10.

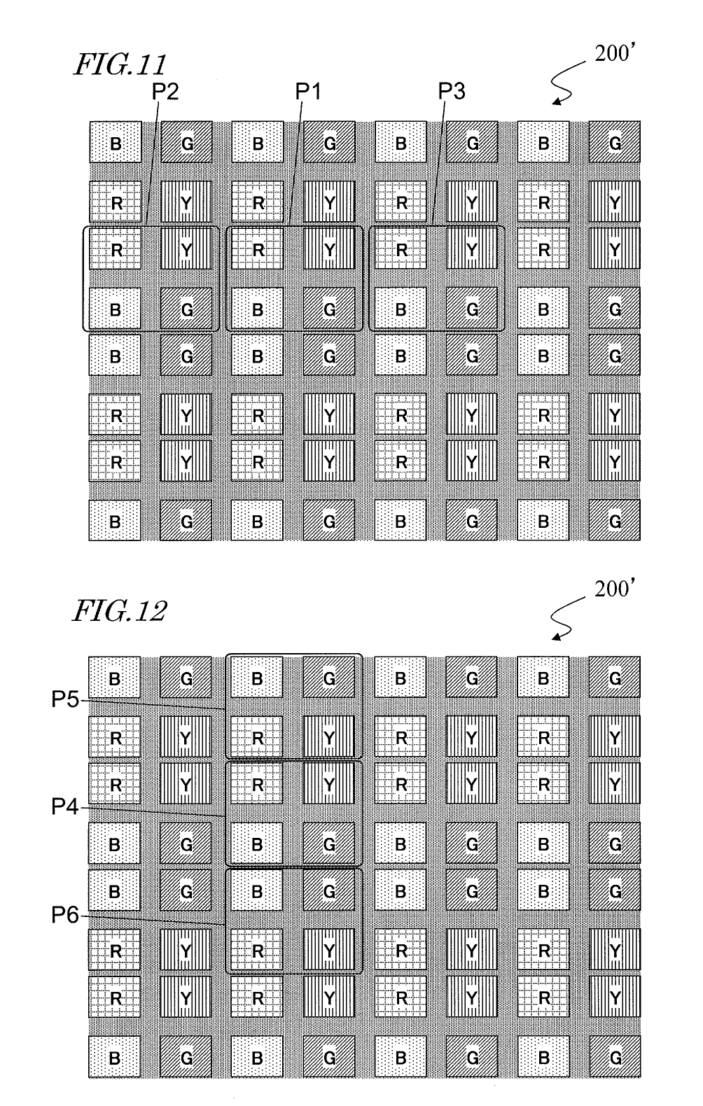

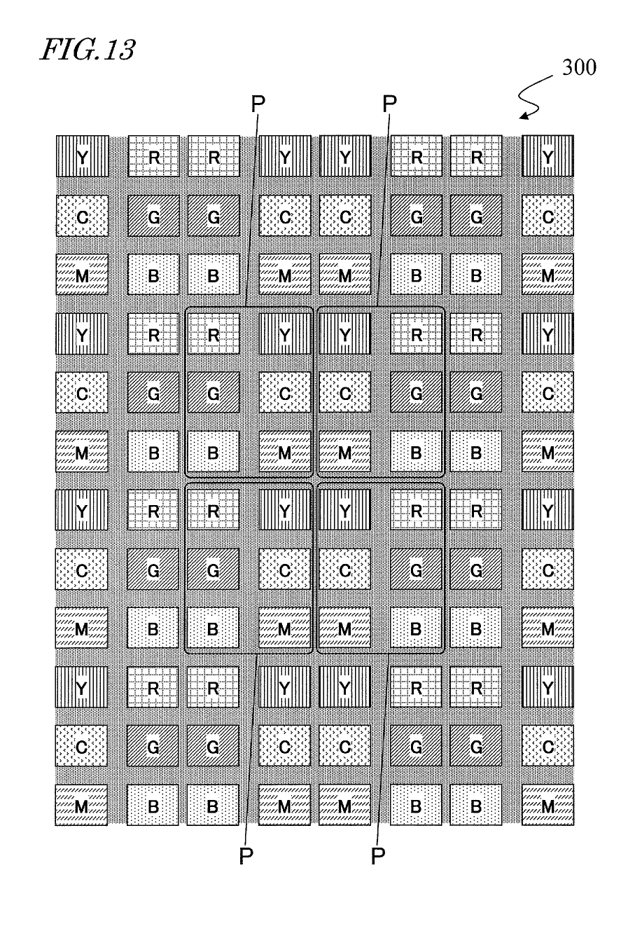

In the liquid crystal display device 200′, each pair of pixels P that are adjacent to each other in the row direction have the same arrangement of subpixels but each pair of pixels P that are adjacent to each other in the column direction have mutually different arrangements of subpixels. Hereinafter, such an arrangement will be described in further detail with reference to FIGS. 11 and 12.

As shown in FIG. 11, when attention is paid to a set of three arbitrary pixels that are arranged in line in the row direction, if the central one of the three is called a first pixel P1 and the other two are called second and third pixels P2 and P3, respectively, the arrangement of the subpixels in the first pixel P1 is the same as that of the subpixels in the second and third pixels P2 and P3.

Meanwhile, when attention is paid to another set of three arbitrary pixels that are arranged in line in the column direction, if the central one of the three is called a fourth pixel P4 and the other two are called fifth and sixth pixels P5 and P6, respectively, the arrangement of the subpixels in the fourth pixel P4 is different from that of the subpixels in the fifth and sixth pixels P5 and P6 as shown in FIG. 12.

Specifically, red, blue, green and yellow subpixels R, B, G and Y are arranged at the upper left, lower left, lower right and upper right corners, respectively (i.e., counterclockwise from the upper left corner) in the fourth pixel P4 but at the lower left, upper left, upper right, and lower right corners, respectively (i.e., clockwise from the lower left corner) in the fifth and sixth pixels P5 and P6.

If the subpixels are arranged in such patterns, the respective red subpixels R of the fourth and fifth pixels P4 and P5 are adjacent to each other, so are the respective yellow subpixels Y of the fourth and fifth pixels P4 and P5 as shown in FIG. 12. Furthermore, the respective blue subpixels B of the fourth and sixth pixels P4 and P6 are adjacent to each other, so are the respective green subpixels G of the fourth and sixth pixels P4 and P6.

As described above, in this liquid crystal display device 200′, subpixels representing the same color are adjacent to each other only between two pixels P that are adjacent to each other in the column direction. That is why the margin that should be left just in case of misalignment cannot be reduced in the row direction but can be reduced in the column direction. As a result, a portion of the black matrix 23 that is located between subpixels representing the same color can have a decreased width, and therefore, the aperture ratio can be increased compared to the conventional one, in the column direction.

### Embodiment 3

FIG. 13 illustrates a liquid crystal display device 300 as a third specific preferred embodiment of the present invention. Each of the pixels P of this liquid crystal display device 300 is defined by six subpixels that are arrange in two columns and three rows to form a matrix pattern in the pixel P itself. Specifically, the six subpixels that define each pixel P consist of not only red, green, blue and yellow subpixels R, G, B and Y but also cyan and magenta subpixels C and M representing the colors cyan and magenta, respectively.

The liquid crystal display device 300 is a multi-primary-color display device that carries out a display operation using the six primary colors (i.e., red, green, blue, yellow, cyan and magenta) represented by the red, green, blue, yellow, cyan and magenta subpixels R, G, B, Y, C and M, respectively.

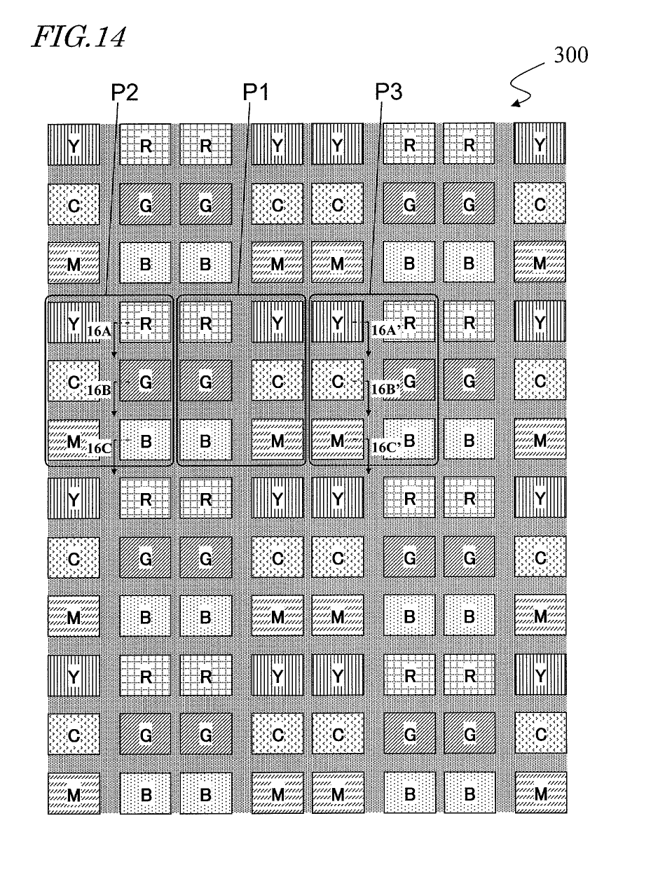

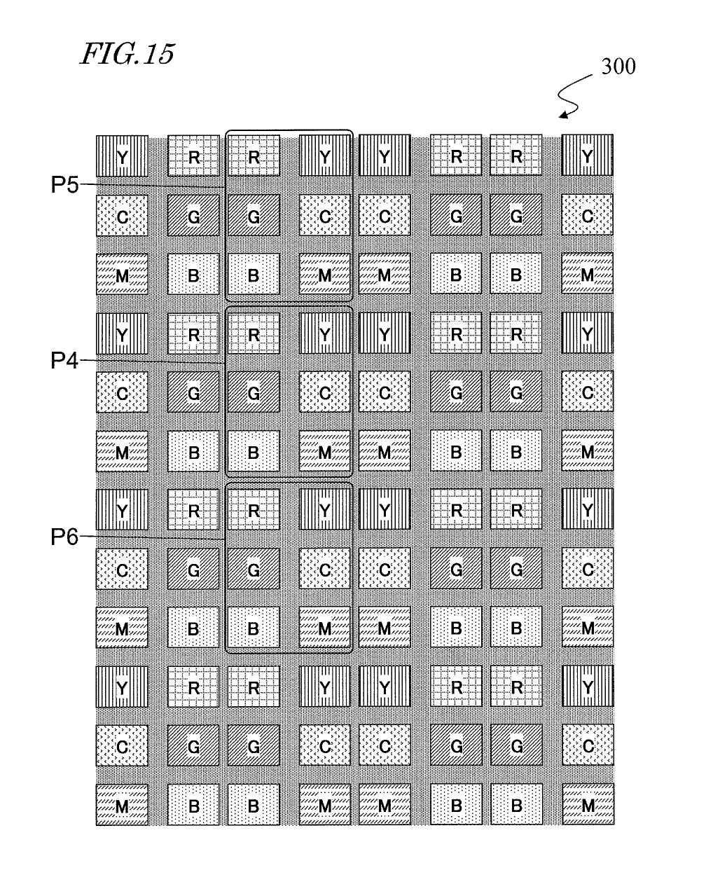

In the liquid crystal display device 300 of this preferred embodiment, each pair of pixels P that are adjacent to each other in the row direction have mutually different arrangements of subpixels. Hereinafter, such an arrangement will be described in further detail with reference to FIGS. 14 and 15.

As shown in FIG. 14, when attention is paid to a set of three arbitrary pixels that are arranged in line in the row direction, if the central one of the three is called a first pixel P1 and the other two are called second and third pixels P2 and P3, respectively, the arrangement of the subpixels in the first pixel P1 is different from that of the subpixels in the second and third pixels P2 and P3.

Specifically, red, green, blue, magenta, cyan and yellow subpixels R, G, B, M, C and Y are arranged counterclockwise from the upper left corner in the first pixel P1 but clockwise from the upper right corner in the second and third pixels P2 and P3.

If the subpixels are arranged in such patterns, the respective red subpixels R of the first and second pixels P1 and P2 are adjacent to each other, so are the respective green subpixels G of the first and second pixels P1 and P2 and their blue subpixels B as shown in FIG. 14. Furthermore, the respective yellow subpixels Y of the first and third pixels P1 and P3 are adjacent to each other, so are the respective cyan subpixels C of the first and third pixels P1 and P3 and their magenta subpixels M.

Meanwhile, when attention is paid to another set of three arbitrary pixels that are arranged in line in the column direction, if the central one of the three is called a fourth pixel P4 and the other two are called fifth and sixth pixels P5 and P6, respectively, the arrangement of the subpixels is the same in all of the fourth, fifth and sixth pixels P4, P5 and P6 as shown in FIG. 15.

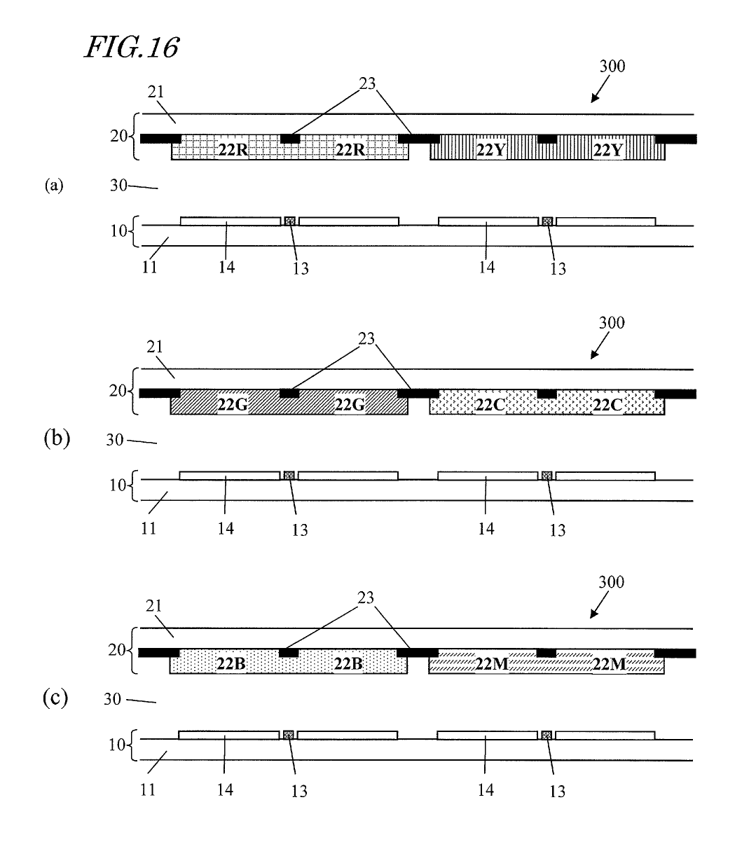

FIG. 16 illustrates cross-sectional structures of the liquid crystal display device 300. FIGS. 16(a), 16(b) and 16(c) are cross-sectional views as viewed on the planes 16A-16A′, 16B-16B′ and 16C-16C′, respectively, shown in FIG. 14. In FIG. 16, any component also included in the liquid crystal display device 100 shown in FIGS. 4 and 5 and having substantially the same function as its counterpart is identified by the same reference numeral and description thereof will be omitted herein.

On the color filter substrate (counter substrate) 20 of this liquid crystal display device 300, not only red, green, blue, and yellow color filters 22R, 22G, 22B and 22Y but also cyan and magenta color filters 22C and 22M are provided in a region allocated to its associated pixel P as shown in FIG. 16. Those color filters 22R, 22G, 22B, 22Y, 22C and 22M are arranged in two columns and three rows in a region allocated to its associated pixel P so as to form a matrix pattern.

As already described with reference to FIG. 14, the arrangement of multiple subpixels in the first pixel P1 is different from that of subpixels in the second and third pixels P2 and P3. Accordingly, the arrangement of those color filters 22R, 22G, 22B, 22Y, 22C and 22M in the region associated with the first pixel P1 is different from that of color filters 22R, 22G, 22B, 22Y, 22C and 22M in the regions associated with the second and third pixels P2 and P3.

Specifically, as the red, green, blue, magenta, cyan and yellow subpixels R, G, B, M, C and Y are arranged counterclockwise from the upper left corner in the first pixel P1, the red, green, blue, magenta, cyan and yellow color filters 22R, 22G, 22B, 22M, 22C and 22Y are also arranged counterclockwise from the upper left corner. On the other hand, as the red, green, blue, magenta, cyan and yellow subpixels R, G, B, M, C and Y are arranged clockwise from the upper right corner in the second and third pixels P2 and P3, the red, green, blue, magenta, cyan and yellow color filters 22R, 22G, 22B, 22M, 22C and 22Y are also arranged clockwise from the upper right corner.

If those color filters 22R, 22G, 22B, 22Y, 22C and 22M are arranged in such patterns, the respective red color filters 22R in the regions associated with the first and second pixels P1 and P2 are adjacent to each other as shown on the left-hand side of FIG. 16(a), so are the respective green color filters 22G in the regions associated with the first and second pixels P1 and P2 as shown on the left-hand side of FIG. 16(b). Furthermore, the respective blue color filters 22B in the regions associated with the first and second pixels P1 and P2 are also adjacent to each other as shown on the left-hand side of FIG. 16(c).

Furthermore, the respective yellow color filters 22Y in the regions associated with the first and third pixels P1 and P3 are adjacent to each other as shown on the right-hand side of FIG. 16(a), so are the respective cyan color filters 22C in the regions associated with the first and third pixels P1 and P3 as shown on the right-hand side of FIG. 16(b). Furthermore, the respective magenta color filters 22M in the regions associated with the first and third pixels P1 and P3 are also adjacent to each other as shown on the right-hand side of FIG. 16(c).

As can be seen, in the color filter substrate 20 of this liquid crystal display device 300, two color filters in the same color are adjacent to each other in any two pixels P that are adjacent to each other in the row direction. As shown in FIG. 16, each pair of mutually adjacent color filters in the same color are arranged in line (i.e., formed integrally). That is why a portion of the black matrix 23 that is located between those subpixels representing the same color is entirely covered with the material of the color filters.

As described above, in the liquid crystal display device 300, two subpixels representing the same color are adjacent to each other in any two pixels P that are adjacent in the row direction. Consequently, a margin that should be left in the row direction in case of misalignment can be cut down. As a result, that portion of the black matrix 23 that is located between those subpixels representing the same color can have a narrower width, and the aperture ratio can be increased accordingly compared to the conventional one.

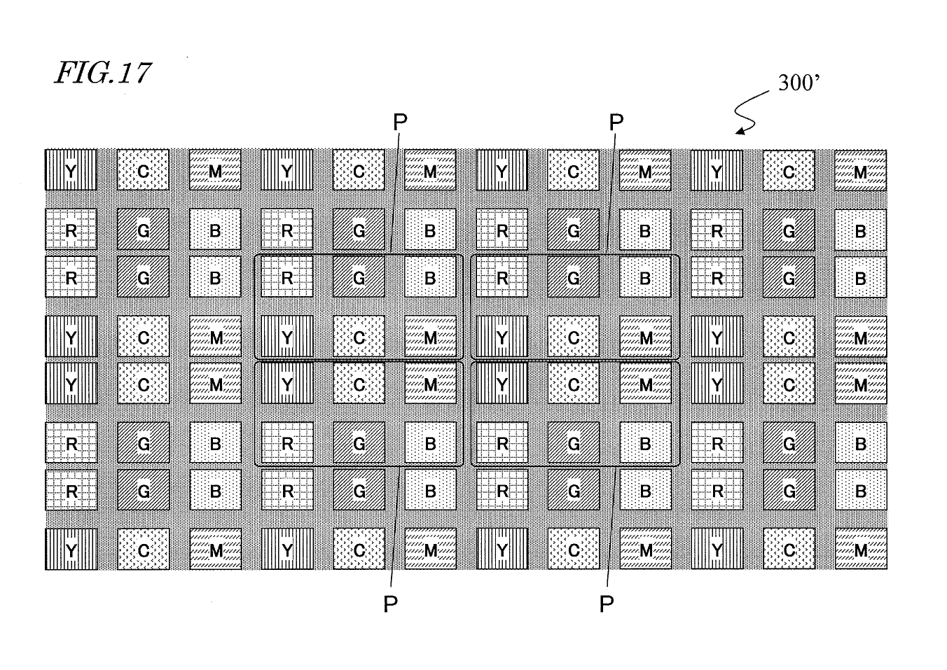

Although an arrangement in which subpixels representing the same color are adjacent to each other only in the row direction is shown in FIGS. 13 to 15, subpixels representing the same color may also be adjacent to each other only in the column direction as in the liquid crystal display device 300′ shown in FIG. 17.

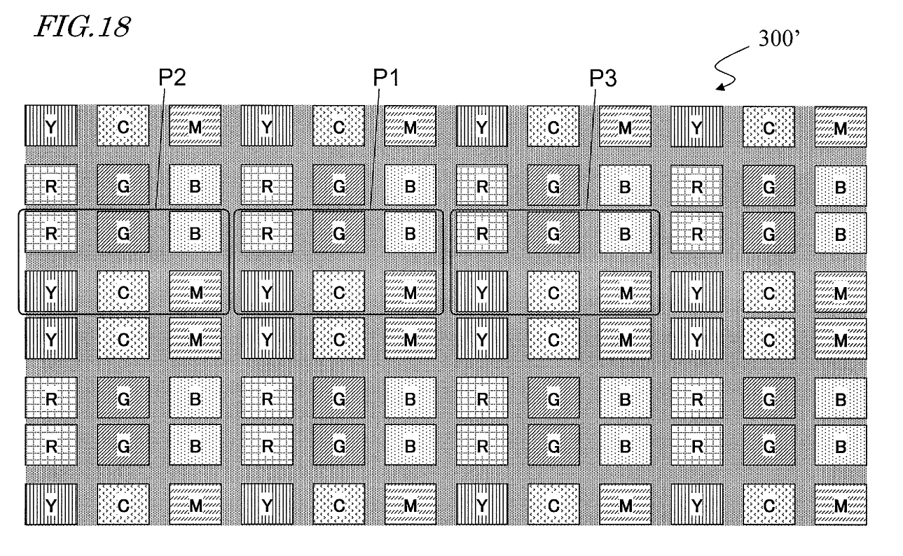

In the liquid crystal display device 300′, each pair of pixels P that are adjacent to each other in the column direction have mutually different arrangements of subpixels. Hereinafter, such an arrangement will be described in further detail with reference to FIGS. 18 and 19.

As shown in FIG. 18, when attention is paid to a set of three arbitrary pixels that are arranged in line in the row direction, if the central one of the three is called a first pixel P1 and the other two are called second and third pixels P2 and P3, respectively, the arrangement of the subpixels in the first pixel P1 is the same as that of the subpixels in the second and third pixels P2 and P3.

Meanwhile, when attention is paid to another set of three arbitrary pixels that are arranged in line in the column direction, if the central one of the three is called a fourth pixel P4 and the other two are called fifth and sixth pixels P5 and P6, respectively, the arrangement of the subpixels in the fourth pixel P4 is different from that of the subpixels in the fifth and sixth pixels P5 and P6 as shown in FIG. 19.

Specifically, red, green, blue, magenta, cyan and yellow subpixels R, G, B, M, C and Y are arranged clockwise from the upper left corner in the fourth pixel P4 but arranged counterclockwise from the lower left corner in the fifth and sixth pixels P5 and P6.

If the subpixels are arranged in such patterns, the respective red subpixels R of the fourth and fifth pixels P4 and P5 are adjacent to each other, so are the respective green subpixels G of the fourth and fifth pixels P4 and P5 and their blue subpixels B as shown in FIG. 19. Furthermore, the respective yellow subpixels Y of the fourth and sixth pixels P4 and P6 are adjacent to each other, so are the respective cyan subpixels C of the fourth and sixth pixels P4 and P6 and their magenta subpixels M.

As described above, in this liquid crystal display device 300′, subpixels representing the same color are adjacent to each other between two pixels P that are adjacent to each other in the column direction. That is why the margin that should be left just in case of misalignment can be reduced in the column direction. As a result, a portion of the black matrix 23 that is located between subpixels representing the same color can have a decreased width, and therefore, the aperture ratio can be increased compared to the conventional one, in the column direction.

In the exemplary arrangements of the first through third preferred embodiments of the present invention described above, each pixel P is supposed to be defined by four or six subpixels. However, the present invention is in no way limited to those specific preferred embodiments. Rather, the present invention is broadly applicable to any arrangement in which each pixel P is defined by a number of subpixels that are arranged in m columns and n rows (where n and m are integers that are equal to or greater than two), i.e., an even number of subpixels, so as to form a matrix pattern. For example, each pixel P may be defined by eight subpixels that are arranged in either four columns and two rows or two columns and four rows.

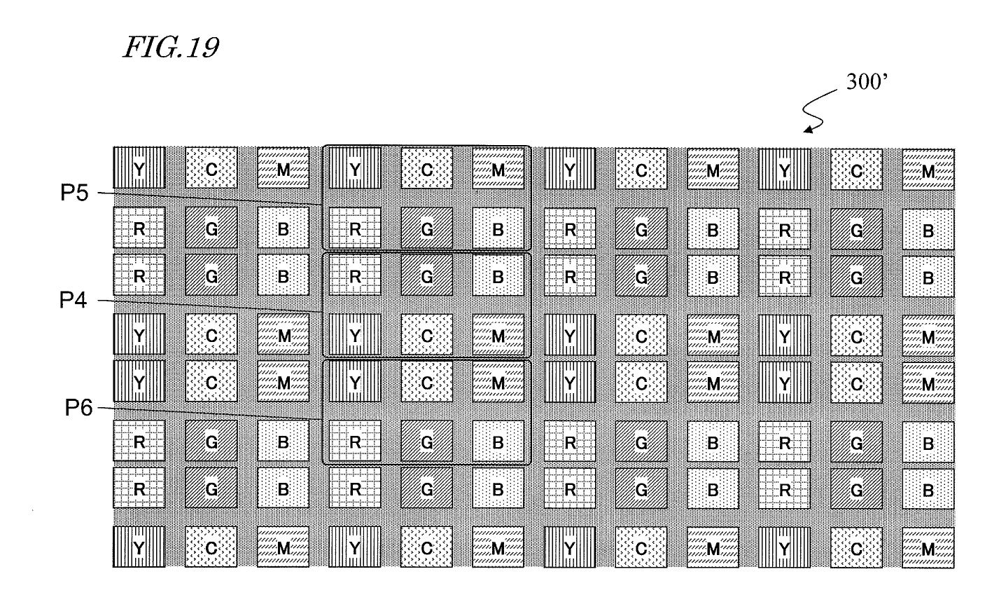

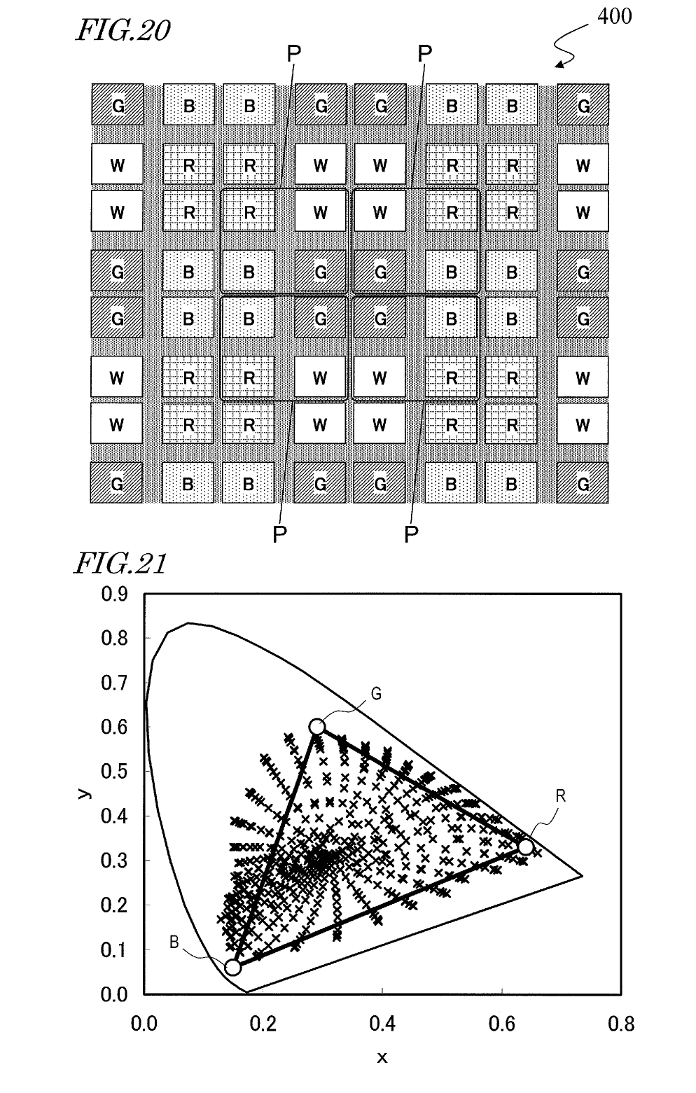

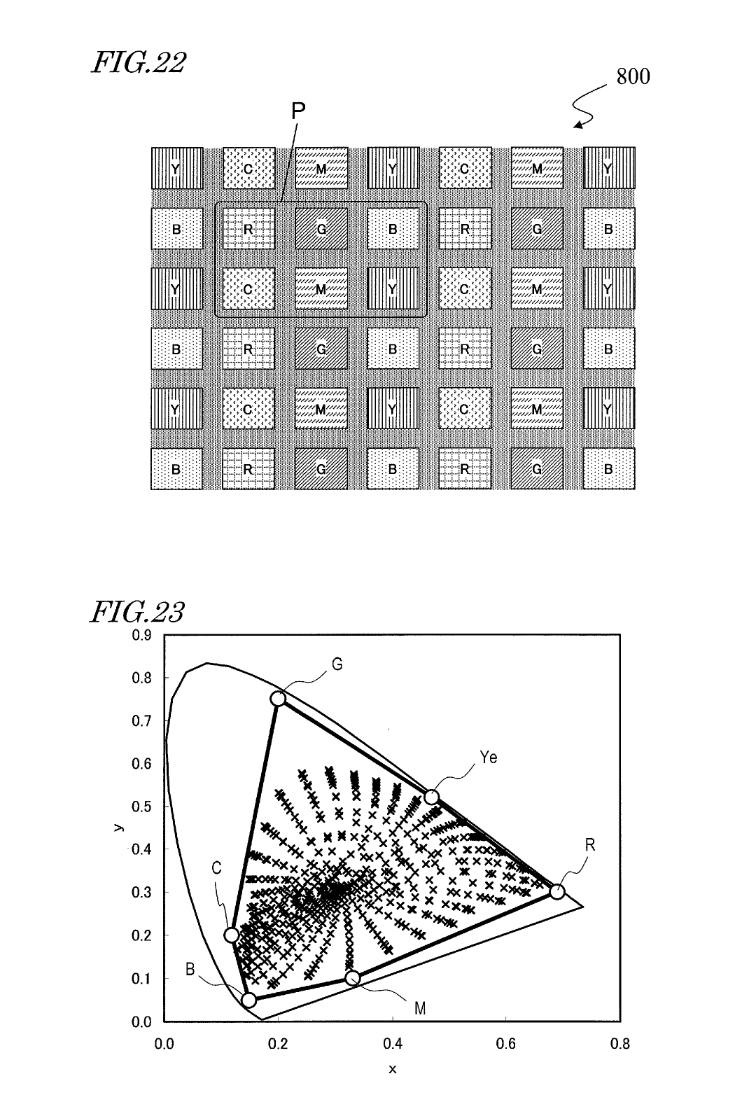

Likewise, the kinds (i.e., the combination) of subpixels that define a single pixel P do not have to be what has been described above, either. For instance, if each pixel P is defined by four subpixels, those four subpixels may be red, green, blue, and cyan subpixels R, G, B and C or red, green, blue, and magenta subpixels R, G, B and M. Alternatively, as in the liquid crystal display device 400 shown in FIG. 20, each pixel P may even be defined by red, green, blue, and white subpixels R, G, B and W. The liquid crystal display device 400 has the same arrangement as the liquid crystal display device 100 shown in FIG. 1 except that the yellow subpixels Y are replaced with white subpixels W representing the color white. On the color filter substrate of the liquid crystal display device 400, a colorless and transparent color filter (i.e., a color filter that transmits white light) is provided in a region allocated to each of those white subpixels W. As the primary color added to the liquid crystal display device 400 is white, the color reproduction range cannot be expanded, but the display luminance of a single pixel P can be increased as a whole. As can be seen, the present invention is broadly applicable to any other arrangement in which each pixel is defined by four or more subpixels.

Furthermore, the present invention does not have to be applied to a liquid crystal display device, either. For example, the present invention is also applicable to an electrophoretic display device with a color filter substrate. Moreover, the present invention is applicable to not just a non-self-emitting display device such as a liquid crystal display device or an electrophoretic display device but also a self-emitting display device such as an organic EL display device as well. Some self-emitting display devices use no color filters. Even if the present invention is applied to such a type of display device, the effect of increasing the aperture ratio can still be achieved. For instance, in an organic EL display device, of which each subpixel is provided with an organic EL layer that directly emits a light ray representing its associated primary color, if multiple subpixels representing the same color are arranged adjacent to each other in the row and/or column direction(s), portions of the organic EL layer emitting a light ray representing the same color can be arranged in line. As a result, the margin that should be ordinarily left in the row and/or column direction(s) just in case of misalignment (that could occur between the black matrix and the organic EL layer) can be eliminated and the aperture ratio can be increased.

### INDUSTRIAL APPLICABILITY

According to the present invention, the aperture ratio of a display device, of which a single pixel is defined by four or more subpixels, can be increased. The present invention can be used effectively in a multi-primary-color display device.

### REFERENCE SIGNS LIST

10 active-matrix substrate (TFT substrate)
11 transparent substrate
12 scan line
13 signal line
14 pixel electrode
20 color filter substrate (counter substrate)
21 transparent substrate
22R red color filter
22G green color filter
22B blue color filter
22Y yellow color filter
22C cyan color filter
22M magenta color filter
23 black matrix
25 columnar spacer
30 liquid crystal layer
P pixel
P1 first pixel
P2 second pixel
P3 third pixel
P4 fourth pixel
P5 fifth pixel
P6 sixth pixel
R red subpixel
G green subpixel
B blue subpixel
Y yellow subpixel
C cyan subpixel
M magenta subpixel
100, 200, 200′, 300, 300′, 400 liquid crystal display device

1. A display device comprising a number of pixels that are arranged in columns and rows to form a matrix pattern,
each said pixel being defined by a number of subpixels that are arranged in m columns and n rows (where n and m are integers that are equal to or greater than two) to form a matrix pattern in itself and that include first, second, third and fourth subpixels representing first, second, third and fourth colors, respectively,
wherein when attention is paid to a set of three arbitrary pixels that are arranged in line in one of row and column directions, if the central one of the three is called a first pixel and the other two are called second and third pixels, respectively,
the arrangement of the subpixels in the first pixel is different from the arrangement of the subpixels in the second and third pixels, and
the respective first subpixels of the first and second pixels are adjacent to each other, so are the respective second subpixels of the first and second pixels, and
the respective third subpixels of the first and third pixels are adjacent to each other, so are the respective fourth subpixels of the first and third pixels.

2. The display device of claim 1, wherein the subpixels are four subpixels that are arranged in two columns and two rows to form a matrix pattern,
wherein when attention is paid to another set of three arbitrary pixels that are arranged in line in the other of the column and row directions, if the central one of the three is called a fourth pixel and the other two are called fifth and sixth pixels, respectively,
the arrangement of the subpixels in the fourth pixel is different from the arrangement of the subpixels in the fifth and sixth pixels, and
the respective first subpixels of the fourth and fifth pixels are adjacent to each other, so are the respective third subpixels of the fourth and fifth pixels, and
the respective second subpixels of the fourth and sixth pixels are adjacent to each other, so are the respective fourth subpixels of the fourth and sixth pixels.

3. The display device of claim 1, wherein the first, second, third and fourth subpixels are red, green, blue and yellow subpixels representing the colors red, green, blue and yellow, respectively.

4. The display device of claim 1, wherein the subpixels further include fifth and sixth subpixels representing fifth and sixth colors, respectively, and
wherein the respective fifth subpixels of the first and second pixels are adjacent to each other, so are the respective sixth subpixels of the first and third pixels.

5. The display device of claim 4, wherein the first, second, third, fourth, fifth and sixth subpixels are red, green, blue, yellow, cyan and magenta subpixels representing the colors red, green, blue, yellow, cyan and magenta, respectively.

6. A display device comprising a number of pixels that are arranged in columns and rows to form a matrix pattern,
each said pixel being defined by four subpixels that are arranged in two columns and two rows to form a matrix pattern in itself and that are first, second, third and fourth subpixels representing first, second, third and fourth colors, respectively,
wherein when attention is paid to two arbitrary pixels that are arranged adjacent to each other in a row direction, each subpixel of one of the two pixels and its associated subpixel of the other pixel are arranged symmetrically to each other with respect to a boundary between the two pixels, and
wherein when attention is paid to two arbitrary pixels that are arranged adjacent to each other in a column direction, each subpixel of one of the two pixels and its associated subpixel of the other pixel are arranged symmetrically to each other with respect to a boundary between the two pixels.

7. The display device of claim 1, wherein the display device is a liquid crystal display device comprising two substrates and a liquid crystal layer that is interposed between the two substrates.

8. The display device of claim 7, further comprising columnar spacers, which define the gap between the two substrates,
wherein no columnar spacers are provided between two adjacent subpixels that represent the same color.

9. A color filter substrate for use to make a display device, the display device having a number of pixels that are arranged in columns and rows to form a matrix pattern,
the color filter substrate comprising
a transparent substrate, and
multiple color filters, which are arranged in an area on the transparent substrate so as to face the pixels, and
wherein the color filters are arranged in m columns and n rows (where n and m are integers that are equal to or greater than two) to form a matrix pattern in that area and that include first, second, third and fourth color filters that transmit light rays representing first, second, third and fourth colors, respectively,
wherein when attention is paid to a set of three arbitrary pixels that are arranged in line in one of row and column directions, if the central one of the three is called a first pixel and the other two are called second and third pixels, respectively,
the arrangement of the color filters in a region associated with the first pixel is different from the arrangement of the color filters in regions associated with the second and third pixels, and
the respective first color filters in two regions associated with the first and second pixels are adjacent to each other, so are the respective second color filters in the two regions associated with the first and second pixels, and
the respective third color filters in two regions associated with the first and third pixels are adjacent to each other, so are the respective fourth color filters in the two regions associated with the first and third pixels.

10. The color filter substrate of claim 9, wherein the color filters are four color filters that are arranged in two columns and two rows to form a matrix pattern,
wherein when attention is paid to another set of three arbitrary pixels that are arranged in line in the other of the column and row directions, if the central one of the three is called a fourth pixel and the other two are called fifth and sixth pixels, respectively,
the arrangement of the color filters in a region associated with the fourth pixel is different from the arrangement of the color filters in regions associated with the fifth and sixth pixels, and
the respective first color filters in two regions associated with the fourth and fifth pixels are adjacent to each other, so are the respective third color filters in the two regions associated with the fourth and fifth pixels, and
the respective second color filters in two regions associated with the fourth and sixth pixels are adjacent to each other, so are the respective fourth color filters in the two regions associated with the fourth and sixth pixels.

11. The color filter substrate of claim 9, wherein the first, second, third and fourth color filters are red, green, blue and yellow color filters, respectively.

12. The color filter substrate of claim 9, wherein the color filters further include fifth and sixth color filters that transmit light rays representing fifth and sixth colors, respectively, and
wherein the respective fifth color filters in two regions that are associated with the first and second pixels are adjacent to each other, so are the respective sixth color filters in two regions that are associated with the first and third pixels.

13. The color filter substrate of claim 12, wherein the first, second, third, fourth, fifth and sixth color filters are red, green, blue, yellow, cyan and magenta color filters, respectively.

14. The display device of claim 6, wherein the display device is a liquid crystal display device comprising two substrates and a liquid crystal layer that is interposed between the two substrates.

15. The display device of claim 14, further comprising columnar spacers, which define the gap between the two substrates,
wherein no columnar spacers are provided between two adjacent subpixels that represent the same color.
